(19) United States
(12) Patent Application Publication
(10) Pub. No.: US 2016/0327853 A1
(43) Pub. Date: Nov. 10, 2016

(54) TRANSPARENT ACTIVE WINDOW DISPLAY

(71) Applicant: HONEYWELL INTERNATIONAL INC., Morristown, NJ (US)

(72) Inventors: Kalluri S. Sarma, Mesa, AZ (US); Brent D. Larson, Phoenix, AZ (US)

(73) Assignee: HONEYWELL INTERNATIONAL INC., Morristown, NJ (US)

(21) Appl. No.: 14/707,421

(22) Filed: May 8, 2015

(51) Int. Cl. G03B 21/56; G03B 21/62; G03B 29/00; G03B 21/604

(52) U.S. Cl. CPC G03B 21/567; G03B 21/604; G03B 21/62; G03B 29/00

(57) ABSTRACT

An active window display (AWD) system having a first surface that provides a wide field of view image for cross-cockpit viewing that is readable against sunlight illumination is provided. The displayed image in the AWD is not visible from a backside (or second surface) of the AWD. The AWD system further capably switches from transmitting wavelengths to being opaque, to block the optical emissions associated with a displayed image from escaping the backside or second surface.

### TECHNICAL FIELD

Embodiments of the subject matter described herein relate generally to active window display systems and, more particularly, to an active window display system that is not visible from outside a vehicle.

### BACKGROUND

Active window display systems (AWDs) are of interest for a variety of aerospace, military, automotive, industrial and consumer applications. An AWD system generates, on a window, a display or image that is essentially transparent, having a see-through attribute. The AWD system is mounted or laminated on a vehicle window and the display or image may be, for example, the mission information for a military ground vehicle, an aircraft or an automobile.

In many such applications, there is a need for the AWD system to not only display an image that is see-through to the crew viewing it from inside a vehicle, but to provide additional features, such as control and security over the displayed image with respect to the outside of a vehicle, or backside of the display. For example, it is desirable for the image view inside the vehicle to be wide-angle, for cross-cockpit viewing, and to be readable even against sunlight illumination. Additionally, it is desirable for the displayed image to not be visible from outside the vehicle (i.e., the backside of the AWD). It would be further desirable for the AWD system to capably switch from being transparent to being opaque, to block the optical emissions from escaping the vehicle.

The desired AWD features would enable increased situational awareness and safety for a crew. The present invention provides the desired features.

### BRIEF SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

A display system is provided. The display system comprises a projector configured to project a first wavelength of light, and a transparent screen assembly having a first surface and a second surface. The transparent screen assembly is configured to, in response to receiving the first wavelength on the first surface, emit a second wavelength from the first surface and block transmission of the first wavelength and second wavelength from the second surface.

Another display system is provided. The display system comprises a projector configured to project at least one excitation wavelength to create at least one of a (i) red light emission wavelength, (ii) green light emission wavelength and (iii) blue light emission wavelength on a first surface of a transparent screen assembly. The display system also comprises a transparent screen assembly comprising a first surface and a second surface, the transparent screen assembly is configured to, in response to receiving the excitation wavelength, emit a respective second wavelength comprising at least one of a (i) red light emission wavelength, (ii) green light emission wavelength, and (iii) blue light emission wavelength on the first surface, and block transmission of the respective second wavelength and the corresponding excitation wavelength from the second surface while allowing other wavelengths of light to pass through the transparent screen assembly.

Yet another display system is provided. The display system comprises a projector configured to project polarized light with a first output polarization, and a partially transparent screen assembly. The partially transparent screen assembly comprises a scattering polarizer defining a first surface, and an absorbing polarizer defining a second surface and coupled to the scattering polarizer. A rejection axis of the scattering polarizer and a rejection axis of the absorbing polarizer are parallel to each other and perpendicular to a rejection axis associated with the first output polarization. The transparent screen assembly is configured to, in response to receiving the polarized light with the first output polarization on the first surface, (i) backscatter the polarized light with the first output polarization from the first surface, and (ii) block the polarized light with the first output polarization from the from the second surface.

Other desirable features will become apparent from the following detailed description and the appended claims, taken in conjunction with the accompanying drawings and this background.

### BRIEF DESCRIPTION OF THE DRAWINGS

A more complete understanding of the subject matter may be derived by referring to the following Detailed Description and Claims when considered in conjunction with the following figures, wherein like reference numerals refer to similar elements throughout the figures, and wherein:

FIG. 1 is a simplified block diagram of an active window display system according to an exemplary embodiment;

FIG. 2 is an expanded block diagram of FIG. 1, providing additional detail, in accordance with an exemplary embodiment;

FIG. 3 is an illustration of the use of an optical reflection filter to block transmission of the displayed image, in accordance with an exemplary embodiment;

FIG. 4 is an illustration of the use of an optical absorption filter to block transmission of the displayed image, in accordance with another exemplary embodiment;

FIG. 5 is an expanded block diagram of FIG. 1, providing additional detail, in accordance with another exemplary embodiment;

FIG. 6 is a simplified timing diagram depicting the use of an electro-optic shutter such as an electro-chromic window film to block transmission of the displayed image, in accordance with an exemplary embodiment;

FIG. 7 is a simplified timing diagram depicting an electro-optic shutter such as an electro-chromic window film that is synchronized with a projector in frame sequential mode, to block transmission of the displayed image, in accordance with an exemplary embodiment; and

FIG. 8 is a simplified timing diagram depicting an electro-optic shutter such as an electro-chromic window film that is synchronized with a projector in both frame sequential and color sequential mode, to block transmission of the displayed image, in accordance with another exemplary embodiment.

### DETAILED DESCRIPTION

The following Detailed Description is merely exemplary in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over any other implementations. Furthermore, there is no intention to be bound by any expressed or implied theory presented in the preceding Technical Field, Background, Brief Summary or the following Detailed Description.

For the sake of brevity, conventional techniques related to known graphics and image processing, sensors, and other functional aspects of certain systems and subsystems (and the individual operating components thereof) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Techniques and technologies may be described herein in terms of functional and/or logical block components and with reference to symbolic representations of operations, processing tasks, and functions that may be performed by various computing components or devices. Mechanisms to control features such as the projector 102 and/or an electro-optic shutter 206 such as an electro-chromic window film, or a liquid crystal optical shutter/light valve may utilize processors and memory. Such operations, tasks, and functions are sometimes referred to as being processor-executed, computer-executed, computerized, software-implemented, or computer-implemented. In practice, one or more processor devices can carry out the described operations, tasks, and functions by manipulating electrical signals representing data bits at memory locations in the processor electronics of the display system, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following descriptions may refer to elements or nodes or features being “coupled” together. As used herein, and consistent with the discussion hereinabove, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting.

The embodiments described herein are merely examples and serve as guides for implementing the novel systems and methods on any window in any avionics, astronautics, terrestrial, or water application. As used herein, an “image” includes one to a plurality of wavelengths of light in a predetermined pattern. The image may include any combination of symbology, alphanumeric information, video, and/or figures. It is readily appreciated that the relevant windows are also designed to meet a plurality of environmental and safety standards beyond the scope of the examples presented below. As such, the examples presented herein are intended as non-limiting.

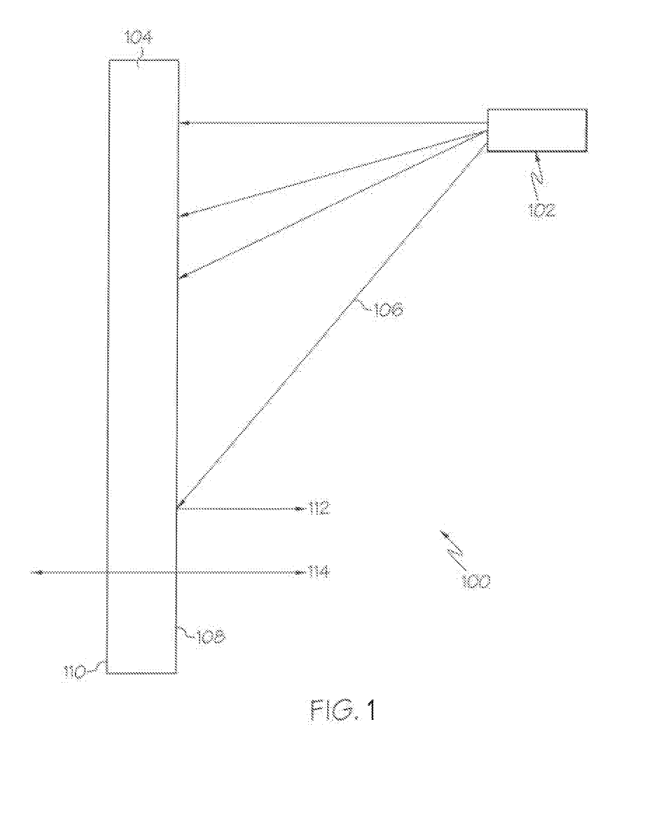

FIG. 1 is a simplified block diagram of an active window display system 100 according to an exemplary embodiment. Projector 102 is configured to project a dynamic or static image, constituting one or more narrow wavelength bands of light, (for example, first wavelength 106), onto the first surface 108 of a substantially transparent screen assembly 104 Various embodiments of transparent screen assembly 104 may be employed, and each screen assembly 104 may have regions that are substantially planar as well as regions that have curvature.

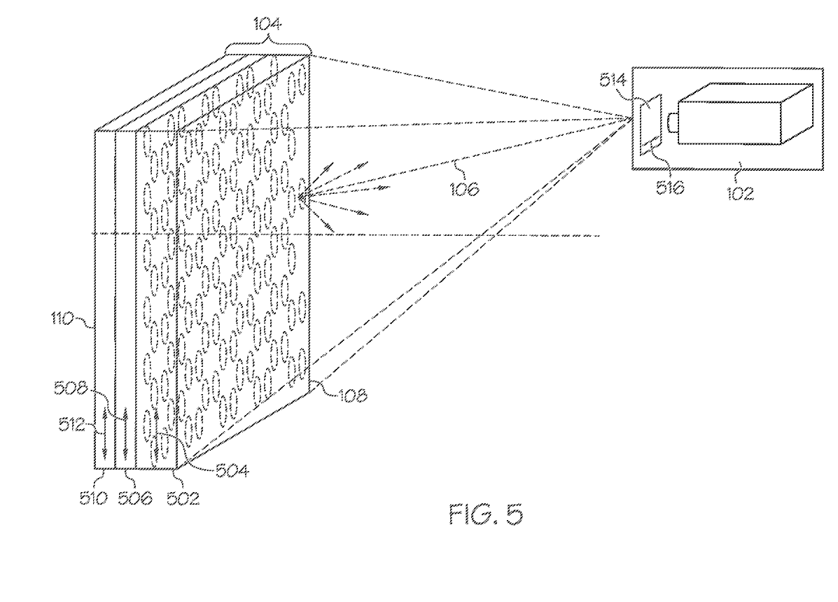

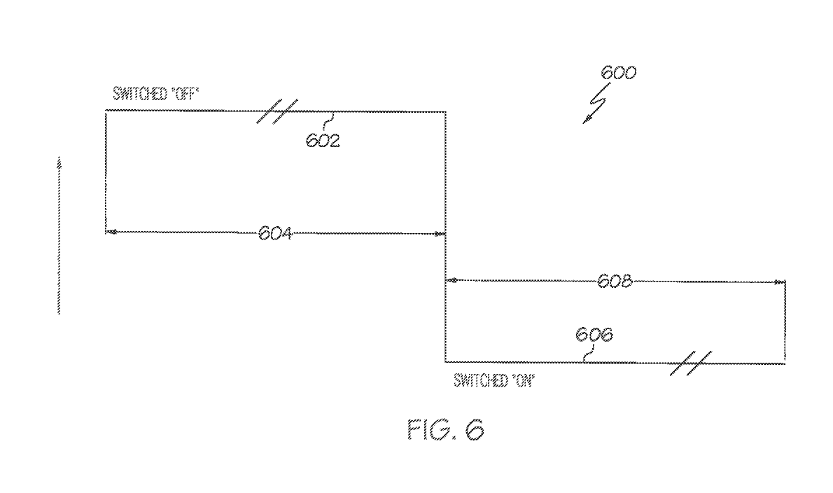

The projector 102 is a source that projects an image, as individual narrow wavelength bands of light (hereinafter, the individual narrow wavelength bands of light may be referred to as just “wavelengths”). The projector 102 may be under electronic and/or mechanical control and may employ various methods for projecting individual frames of an image. Accordingly the projector 102 may be responsible for creating an image, may be adjusted to have a brightness that maintains display visibility in the presence of sunlight or other ambient light, and may employ various synchronized shuttering techniques. In some embodiments, the projector 102 may employ a polarizer prior to projection, such that the projected image has an output polarization (FIG. 5). In another embodiment, the projector 102 operates in frame sequential mode and in yet another embodiment, the projector 102 operates in both frame sequential and color sequential mode. In one example of the latter embodiment, the projector 102 switches image frames at 60 Hz and within each frame, the red, green, and blue wavelength components of the image are switched at 180 Hz. Details of various switching modes are described below, in connection with FIGS. 6-8.

In response to reception of the first wavelength 106 at the first surface 108 of transparent screen assembly 104, a second wavelength 112 is emitted from the first surface 108. The second wavelength 112 may or may not be substantially the same as the first wavelength 106. Ambient wavelengths of ambient light 114, excluding the “target” first wavelength 106, pass through the transparent screen assembly 104. From the perspective of the second surface 110 of transparent screen assembly 104, which is often the “outside” of a vehicle or backside of a display, (excitation) first wavelength 106, and the (emission) second wavelength 112 are blocked and are therefore not passed through or transmitted.

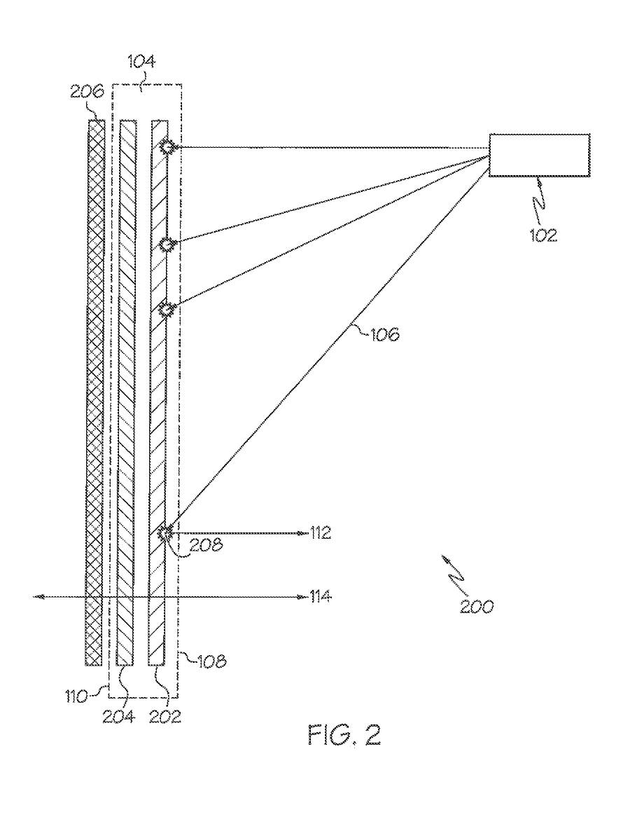

FIG. 2 is an expanded block diagram of FIG. 1, providing additional detail, in accordance with an exemplary embodiment. FIG. 2 is not to scale but provides a visual appreciation for the relative position and orientation of some of the features. In this embodiment, the transparent screen assembly 104 comprises a projection screen 202, defining the first surface, and a filter screen 204, defining the second surface. The projection screen 202 is proximate and coupled to the filter screen 204. An optional electro-optic shutter such as an electro-optic shutter 206 may be adjacent to or coupled to the filter screen 204, for example at second surface 110. The size, thickness, and attributes of projection screen 202, filter screen 204, and optional electro-optic shutter 206 are selected as appropriate for an application.

The projection screen 202 provides color-compatible transparency from the perspective of the first surface 108 (i.e., viewing the first surface from, typically, the inside of a vehicle). In order to provide this color transparency, the projection screen 202 may comprise embedded particles 208. The embedded particles 208 are excited by a received wavelength (referred to herein as the first wavelength 106) and emit a wavelength in response, the emitted wavelength is referred to herein as the second wavelength 112. The embedded particles 208 may comprise fluorescent nanoparticles or molecules. In an alternative embodiment, embedded particles 208 comprise resonant scattering nanoparticles. In yet another embodiment the particles may comprise of quantum dots (QD) tuned for narrow band red, green and blue emissions. Although the emission of second wavelength 112 is shown as unidirectional, coming from the first surface, in practice, emission is typically two or three-dimensional, and the second surface may have a filter screen 204 to prohibit the emission of second wavelength 112 and/or the transmission of first wavelength 106 and second wavelength 112 from the second surface 110 (i.e., from the backside of the AWD or outside of the vehicle).

As mentioned above, while the discussion herein references spectral content such as first wavelength 106 as a singular wavelength, it is to be understood that a wavelength so described is the “individual narrow wavelength band of light” introduced earlier, which will typically involve a spectral band or wavelength range of finite bandwidth, as is well known in the art. The desired spectral bandwidth of each wavelength is application specific and may vary depending upon the properties of the involved projector and/or screen mechanism. In the embodiments described thus far, a relatively narrow spectral bandwidth is generally preferable.

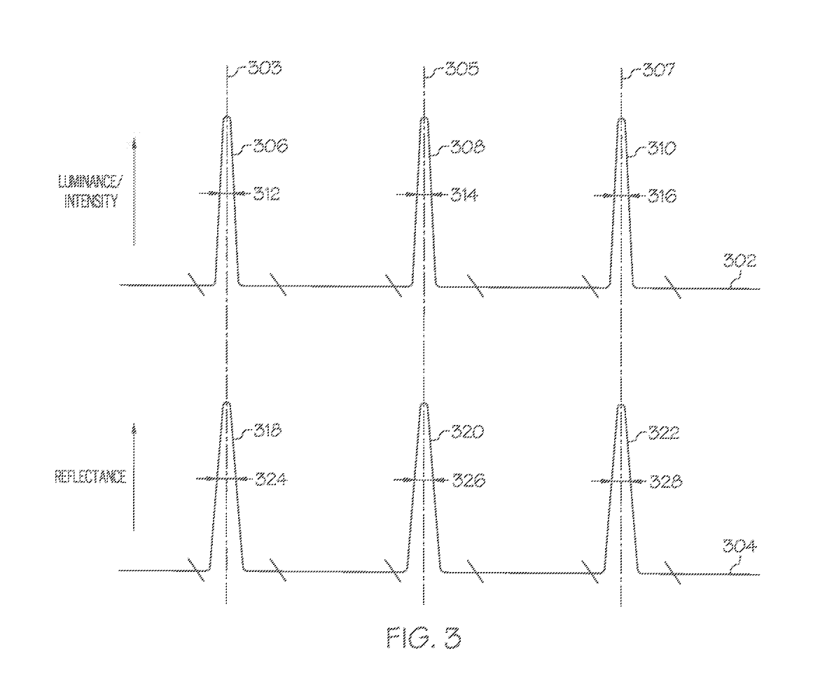

A filter screen 204 may comprise any of several varieties of wide-field-of-view narrow band notch or multi-notch absorption or reflection filters. Wide-field-of-view narrow band multi-notch reflection filters are described in connection with FIG. 3 and tend to be suitable for applications involving somewhat narrower fields-of-view than that provided by various wide-field-of-view narrow band multi-notch absorption filters.

In various embodiments, the filter screen 204 comprises one of (i) absorbing and non-radiative nanoparticles tuned to the first (excitation wavelength) and second (emission) wavelength, (ii) absorbing and non-radiative Quantum Dot (QD) embedded film tuned to the first and second wavelengths, and (iii) film with photonic crystals tuned to the first and second wavelengths. Excitation wavelengths are predominantly in the long wavelength UV band (UVA), or just below blue wavelength band. The filter screen 204 is designed primarily to filter the emitted visible wavelength (red, green or blue), and the small fraction of the excitation wavelength that does not participate in the excitation (down-conversion) process. In some embodiments, such as those employing a resonant nanoparticle projection screen 202, the excitation (projected) wavelength and the scattered wavelength are same. The filter screen 204 is designed to selectively block the projected image wavelengths while allowing all the other wavelengths to pass through. The varieties of filter screens 204 described herein are tuned to one or more respective “target” wavelengths.

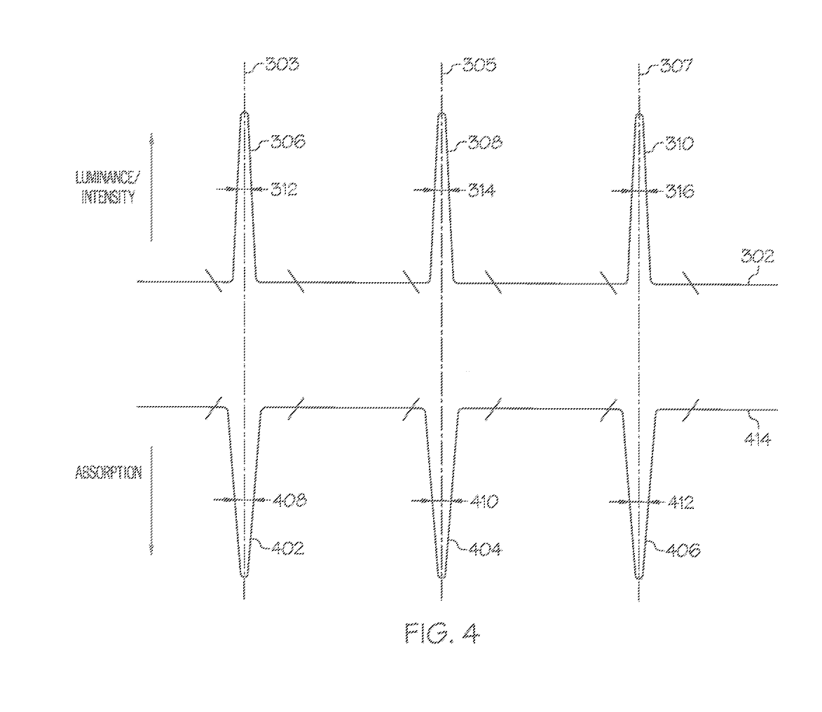

Wide-field-of-view narrow band multi-notch absorption filters include those that employ tuned, absorbing and non-radiative nanoparticles; tuned, absorbing and non-radiative Quantum Dot (QD) embedded films; films with meta-material devices such as photonic crystals; and narrow band dichroic or non-dichroic dyes. Spectral absorption properties of many of these examples can be further enhanced or modified by incorporating them within or in conjunction with tuned multi-layer dielectric structures. Although each of the narrow band multi-notch absorption filters operates slightly differently, each achieves substantially similar absorption objectives with regard to absorbing, or “blocking” one or more target wavelengths, as described in connection with FIG. 4.

Optional electro-optic shutter 206 may be coupled to the first surface 108 or second surface 110 of the transparent screen assembly 104 in various embodiments of the active window display system 200. Electro-optic shutter 206 may be electro-chromic window film, known in the art to switch between the quality of being substantially opaque and the quality of being at least partially transparent, transmitting wavelengths of light, responsive to an applied voltage. In various embodiments, electro-optic shutter 206 may be used to adjust to day and/or night scenarios, for example by attenuating the apparent lighting levels of either side as seen from the opposite side, or to completely secure a window and prevent optical transmissions of an image viewable from the inside a vehicle to the outside of a vehicle (i.e., backside of a display). While known electro-chromic materials and devices are one exemplary approach for switchable opacity windows, the term “electro-chromic” films or layers as used herein is intended to include other compatible structures having electrically tunable transmittance, such as various types of liquid crystal (LC) light valves or similar. Similarly, the term “window film” is intended to be inclusive of thin layer structures which may require support substrates, such as certain types of LC light valves.

Although the electronic controls for the electro-optic shutter 206 are not the subject of the present invention, it is readily appreciated that an electro-optic shutter 206 may operate on a shutter speed, having a corresponding response time, and that such shuttering speed may be coordinated with a shuttering speed of projector 102, as is suitable for an intended application. In practice, the electro-optic shutter 206 may have a shutter speed in the millisecond or sub-millisecond range, as required to support field sequential operations and/or shuttering operations with a projector 102, as described in connection with FIGS. 6-8.

FIG. 3 is an illustration of the use of an optical reflection filter to block transmission of the display, in accordance with an exemplary embodiment. The luminance or intensity of target wavelengths 303, 305, and 307 are displayed along the x-axis 302. A narrow span or band of wavelengths surrounding each target wavelength represents, in practice, the transmitted, emitted and absorbed light. In one embodiment, wavelength 303 is associated with blue light, wavelength 305 is associated with green light, and wavelength 307 is associated with red light. The spans of the individual narrow wavelength bands of light (306, 308, and 310) have respective widths 312, 314, and 316.

A reflective filter blocks transmission of a target wavelength by reflecting at the target wavelength (i.e., the reflective filter is tuned to the target wavelength). In the embodiment shown, the target wavelengths for reflectance are depicted along the x-axis 304. It is readily observable that reflectance 318 is aligned at wavelength 303, reflectance 320 is aligned at wavelength 305, and reflectance 322 is aligned at wavelength 307. As used herein, the filter is considered “tuned” to the target wavelength when a reflection filter wavelength is aligned with a target wavelength as shown. Although FIG. 3 is not to scale, it is readily observable that the width (or the span of individual narrow wavelength bands of light inclusive of a target wavelength), associated with each reflectance wavelength is slightly larger than the associated span of wavelengths related to the luminance at each target wavelength. Specifically, width 324 is larger than width 312, width 326 is larger than width 314, and width 328 is larger than width 316. The additional width in a filter provides design margin, and is selected according to the intended application. It should be noted that certain spectrally selective reflectors can exhibit spectral characteristics that shift with incidence angle of the propagating light. In this case it can be beneficial to adjust the widths of the bands or spans to increase the range of angles to be blocked.

FIG. 4 is an illustration of the use of an optical absorption filter to block transmission of the individual wavelengths of light comprising an image displayed on a window, in accordance with another exemplary embodiment. As previously mentioned, the absorption filters typically provide a wider field-of-view than the reflection filters. The upper portion of FIG. 4 shares with FIG. 3 the same luminance or intensity of wavelengths 303, 305, and 307, displayed along the x-axis 302. The narrow span of wavelengths surrounding each target wavelength represents, in practice, the projected and/or emitted light. Each narrow span of wavelength bands of light (306, 308, and 310) has a respective width 312, 314, and 316.

An absorption filter blocks transmission of a wavelength by absorbing light at a “target” wavelength (i.e., the absorption filter is tuned to the target wavelength). In the embodiment shown, the target wavelengths for absorption are depicted along the x-axis 414. It is readily observable that absorption 402 is aligned at wavelength 303, absorption 404 is aligned at wavelength 305, and absorption 406 is aligned at wavelength 307. Although FIG. 4 is not to scale, it is readily observable that the width (or narrow span of wavelengths surrounding a target wavelength), associated with each absorption wavelength is slightly larger than the associated span of wavelengths related to the luminance at each target wavelength. Specifically, width 408 is larger than width 312, width 410 is larger than width 314, and width 412 is larger than width 316. As previously mentioned, the additional width in a filter provides design margin, and is selected according to the intended application. Embodiments also support selective filtering, used when there are one or more excitation wavelengths that each differ from their respective emission wavelengths, and it is preferable to address additional narrow wavelength bands of light (whether reflective, absorptive or both) to block both the excitation and emission wavelengths.

FIG. 5 is an expanded block diagram of FIG. 1, providing additional detail, in accordance with another exemplary embodiment. In this embodiment, the transparent screen assembly 104 comprises a scattering polarizer 502 defining the first surface and an absorbing polarizer 510 coupled to the scattering polarizer 502 and defining the second surface. An optional reflective polarizer 506 may be located between the scattering polarizer 502 and the absorbing polarizer 510.

In the FIG. 5 embodiment, the projector 102 projects an image through a polarizer 514, in the form of polarized light (providing a first output polarization with an associated rejection axis 516), onto scattering polarizer 502. Each of the sub-components of transparent screen assembly 104 (scattering polarizer 502, absorbing polarizer 510, and optional reflective polarizer 506) have a rejection axis (axis 504, 512, and 508, respectively) that is parallel to each other and substantially perpendicular to the rejection axis 516 associated with the first output polarization. Ambient light 114 wavelengths are transmitted or passed through partially transparent screen assembly 104, as in other embodiments. One distinction from previous embodiments is that one polarization is blocked, as opposed to the blocking of selected target wavelength bands.

The scattering polarizer 502 scatters (or rejects) one polarization of the image along a rejection axis 504 but transmits another. By selectively polarizing the projector 102 to match the rejection axis 504 of the scattering polarizer 502, a portion of the transmitted image will be backscattered to a viewer viewing the first surface. An absorbing polarizer 510 is utilized as a second surface 110 of the scattering polarizer 502 to, upon receiving the polarized light from the projector 102, backscatter the light from the first surface 108 and absorb transmitted light from the second surface 110, thereby absorbing/blocking the projected and forward-scattered portion of the scattered polarization, preventing it from being viewed from the backside of the AWD, or the second surface 110. Ambient light 114, having wavelengths with an orthogonal polarization (orthogonal to the rejection axis 504, 508 of the absorbing polarizer 510 and scattering polarizer 502) are transmitted in both directions without being substantially scattered, blocked, or absorbed.

The scattering polarizer 502 in the FIG. 5 embodiment can take multiple forms. In one example, the scattering polarizer is a film or similar structure containing birefringent microstructural domains or gradients. In another embodiment, scattering polarizer 502 is a fluorescing polarizer which is excited by light of a first wavelength polarized along rejection axis 504 and emits (fluoresces) light of a second wavelength that is substantially polarized.

Additionally, optional variations are possible to improve properties such as transmittance efficiency, leakage of unwanted light, and the like. One skilled in the art will further recognize that various polarization manipulation techniques, such as the use of birefringent films and retarders to enable relative rotations of the polarizers, can be used without changing the intended functionality of the disclosed approach. For example, the polarization-based approach in FIG. 5 includes an optional reflective polarizer 506 between the scattering/fluorescing polarizer 502 and the absorbing polarizer 510. As this polarization-based approach does not rely upon individual narrow wavelength bands of light, filter screen 204 as depicted in FIG. 2 would be optional, but not required. This polarization-based approach can be utilized independently, or in combination with other single-side projection screen approaches (e.g. the narrow-band and time-sequential embodiments described herein).

In another embodiment, instead of coupling the optional electro-optic shutter 206 to the second surface 110 of the transparent screen assembly 104, the electro-optic shutter 206 may be coupled to either side of an included filter screen 204. In yet another embodiment, a polarization rotating film may be used in place of or proximate optional reflective polarizer 506, between scattering polarizer 502 and absorbing polarizer 510, allowing the physical orientation of an axis 512 to be changed while still maintaining an effectively parallel relationship with axis 504.

Various embodiments may have temporal filtering aspects, as described in connection with FIGS. 6, 7 and 8. An exemplary display system with temporal filtering aspects may comprise a projector 102 operated in a frame sequential mode, projecting the image during one frame period and switched “off” during the next frame period, in a continuous fashion. Accordingly, the electro-optic shutter 206 is switched synchronously with the projector to be “on,” thereby substantially opaque, during the frame period when the projector 102 is transmitting/projecting an image. During the frame period when the projector is switched “off,” the electro-optic shutter 206 is in the substantially transparent, “transmissive,” state, allowing wavelengths of light to pass, achieving the transparent active window display attribute. This switching behavior is described in more detail as follows.

FIG. 6 is a simplified timing diagram 600 depicting the use of an electro-optic shutter 206 to block transmission of the displayed image, in accordance with an exemplary embodiment. Electro-optic shutter 206 is switched “off” 602 for duration of time 604, and switched “on” 606 for duration of time 608. When the electro-optic shutter 206 is switched “off” 602, there is transmission of light through the window (i.e., transmission of light through transparent screen assembly 104). For general blocking of the windows, substantially prohibiting visibility through the window (from the inside to the outside, and from the outside to the inside), the electro-optic shutter 206 may be switched “on.” In practice, switching the electro-optic shutter 206 “on” may be applicable at night time, for security reasons, or as suitable to the application.

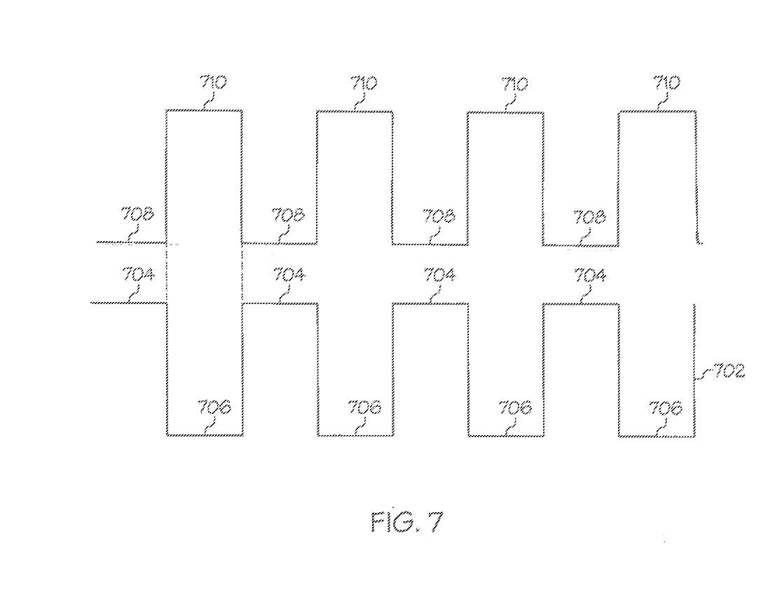

FIG. 7 is a simplified timing diagram depicting an electro-optic shutter 206 that is switched synchronously with a projector 102 in frame sequential mode, to block transmission of the displayed image, in accordance with an exemplary embodiment. In frame sequential mode, the projector 102 output is shown with waveform 702, the projector 102 is essentially “on” (i.e., projecting an image) for one frame and “off” (i.e., not projecting an image) for the next (adjacent) frame. In frame sequential mode, the projector 102 continuously alternates, at a switching speed between “on” 704 and “off” 706. Accordingly, the electro-optic shutter 206 operates at the same switching speed as the projector 102, in order to ensure that the electro-optic shutter 206 is opaque 708 when the projector 102 is “on,” and the electro-optic shutter 206 is at least partially transparent 710 (wherein “partially transparent” may mean less than fifty percent transmittance) when the projector 102 is “off” When the duration of opaque 708 time is equal to the duration of (at least partially) transparent 710 time, only half of the outside light comes in, when considered over time, however all of the display is blocked every time the projector 102 is projecting. In an embodiment, the switching speed of the projector 102 is 60 Hz.

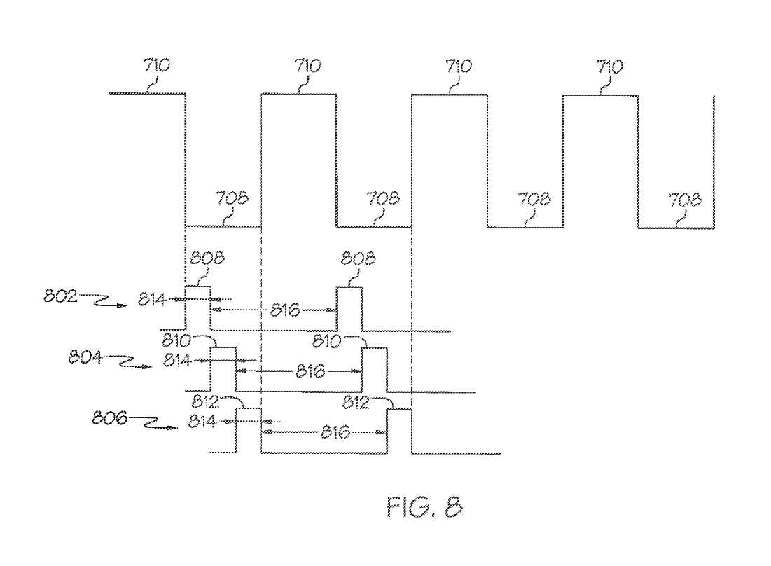

FIG. 8 is a simplified timing diagram depicting an electro-optic shutter 206 that is switched synchronously with a projector 102 in both frame sequential and color sequential mode, to block transmission of the displayed image, in accordance with another exemplary embodiment. In this embodiment, electro-optic shutter 206 alternates between substantially opaque 708 and at least partially transparent 710, similar to its switching protocol in FIG. 7. However, in FIG. 8, the projector 102 sequentially projects, each at a switching speed that is three times faster than the switching speed of the electro-optic shutter 206, subframes 802, 804, and 806. Subframe 802 may be considered to be “on” at 808, subframe 804 may be considered to be “on” at 810, and subframe 806 may be considered to be “on” at 812. The subframes may represent, for example, projection time for different color wavelengths. As discussed earlier, electro-chromic window film is an example for a (transmission modulating) electro-optic shutter 206 that operates with a respective switching speed. Other options for an electro-optic shutter 206 include a liquid crystal light valve or a MEMs-based optical shutter. As may be readily understood, the electro-optic shutters 206 (e.g. electro-chromic window) may advantageously be used to make the windows continuously substantially opaque.

In an embodiment, subframe 812 is associated with blue light, subframe 810 is associated with green light, and subframe 808 is associated with red light. Each subframe 808, 810, and 812, may be cycled “on” for a respective duration of time 814, and “off” for duration of time 816. As in FIG. 7, the electro-optic shutter 206 is synchronized with the projector 102 such that the image (or any of its component wavelengths) coming from the projector 102 is blocked from being transmitted through the transparent screen assembly 104. However, the transparent screen assembly 104 remains transparent when the projector 102 is “off,” or not transmitting an image. Many additional variations are possible, such as other color combinations and timing, provided the electro-optic shutter 206 is substantially opaque/blocking or absorbing (non-transmitting) when the projected light and/or emitted light reaches it. As with the embodiment of FIG. 5, the inclusion of filter screen 204 in the present embodiment is optional. The further incorporation of polarization methods is also optional.

Thus, an AWD system that provides more control and security over the displayed image with respect to the outside of a vehicle, or backside of the AWD is provided. The AWD system provides a wide-angle image for cross-cockpit viewing that is readable against sunlight illumination. The displayed image in the AWD is not visible from outside the vehicle (i.e., the backside of the AWD). The AWD further capably switches from transmitting wavelengths to being opaque, to block the optical emissions from escaping the vehicle.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A display system, comprising:
a projector configured to project a first wavelength of light;
a transparent screen assembly having a first surface and a second surface, the transparent screen assembly configured to, in response to receiving the first wavelength on the first surface,
emit a second wavelength from the first surface; and
block transmission of the first wavelength and second wavelength from the second surface.

2. The display system of claim 1, wherein the transparent screen assembly comprises:
a projection screen defining the first surface; and
a filter screen coupled to the projection screen and defining the second surface, the filter screen tuned to the first wavelength.

3. The display system of claim 2, wherein the filter screen comprises a wide field of view narrow band multi-notch absorption filter tuned to absorb the first wavelength while allowing other wavelengths of light to pass.

4. The display system of claim 3, wherein the filter screen further comprises at least one of (i) absorbing and non-radiative nanoparticles tuned to the first wavelength and second wavelength, (ii) absorbing and non-radiative Quantum Dot (QD) embedded film tuned to the first and second wavelengths, and (iii) film with photonic crystals tuned to the first and second wavelengths.

5. The display system of claim 2, wherein the filter screen comprises a wide field of view narrow band multi-notch reflection filter tuned to the first and second wavelengths.

6. The display system of claim 2, wherein the second wavelength further comprises at least one of: red light wavelength, green light wavelength and blue light wavelength:

7. The display system of claim 2, wherein the projection screen comprises (i) fluorescent nanoparticles or (ii) resonant scattering nanoparticles.

8. The display system of claim 2, further comprising an electro-optic shutter coupled to the filter screen and configured to block transmission of light through the transparent screen assembly.

9. The display system of claim 8, wherein the electro-optic shutter is synchronized with the projector such that (i) when the projector is projecting, the electro-optic shutter is substantially opaque, and (ii) when the projector is not projecting, the electro-optic shutter is at least partially transparent.

10. The display system of claim 8, wherein:
the second wavelength further comprises at least one of: a red light wavelength, a green light wavelength and a blue light wavelength;
the electro-optic shutter is switched with a first switching speed, and
the projector is switched with a switching speed of at least three times the first switching speed.

11. The display system of claim 10, wherein the electro-optic shutter comprise a liquid crystal display (LCD) synchronized shutter or an electro-chromic window film synchronized shutter.

12. The display system of claim 1, wherein first wavelength projected by the projector has a first output polarization and wherein the transparent screen assembly comprises:
a scattering polarizer defining the first surface; and
an absorbing polarizer defining the second surface and coupled to the scattering polarizer; and
the first wavelength projected by the projector is substantially scattered by the scattering polarizer and substantially absorbed by the absorbing polarizer.

13. The display system of claim 1, wherein the first wavelength projected by the projector comprises a first output polarization, and wherein the transparent screen assembly comprises:
a fluorescing polarizer defining the first surface and configured to, in response to the first wavelength, emit polarized light having the second wavelength; and
an absorbing polarizer defining the second surface and coupled to the fluorescing polarizer, the absorbing polarizer configured to (i) absorb the first wavelength having the first output polarization, and (ii) absorb polarized light having the second wavelength.

14. A display system, comprising:
a projector configured to project at least one excitation wavelength to create at least one of a (i) red light emission wavelength, (ii) green light emission wavelength and (iii) blue light emission wavelength on a first surface of a transparent screen assembly; and
a transparent screen assembly comprising a first surface and a second surface, the transparent screen assembly configured to, in response to receiving the excitation wavelength,
emit a respective second wavelength comprising at least one of a (i) red light emission wavelength, (ii) green light emission wavelength, and (iii) blue light emission wavelength on the first surface, and
block transmission of the respective second wavelength and the corresponding excitation wavelength from the second surface while allowing other wavelengths of light to pass through the transparent screen assembly.

15. The display system of claim 14, wherein the transparent screen assembly comprises:
a projection screen defining the first surface,
a filter screen coupled to the projection screen and defining the second surface, the filter screen tuned to the at least one of: the red light emission wavelength, the green light emission wavelength and the blue light emission wavelength.

16. The display system of claim 15, wherein the filter screen comprises at least one of (i) absorbing and non-radiative nanoparticles tuned to the second wavelength, (ii) absorbing and non-radiative Quantum Dot (QD) embedded film tuned to the second wavelength, and (iii) film with photonic crystals.

17. The display system of claim 14, further comprising an electro-optic shutter coupled to the second surface, the electro-optic shutter being synchronized with the projector such that (i) when the projector is projecting, the electro-optic shutter is substantially opaque, and (ii) when the projector is not projecting, the electro-optic shutter is at least partially transparent.

18. The display system of claim 17, wherein the electro-optic shutter is an electro-chromic window film with a first switching speed.

19. The display system of claim 18, wherein:
the projector projects at least one excitation wavelength of light with a switching speed of at least three times the first switching speed.

20. A display system, comprising:
a projector configured to project polarized light with a first output polarization; and
a partially transparent screen assembly comprising
a scattering polarizer defining a first surface; and
an absorbing polarizer defining a second surface and coupled to the scattering polarizer; and
wherein a rejection axis of the scattering polarizer and a rejection axis of the absorbing polarizer are parallel to each other and perpendicular to a rejection axis associated with the first output polarization,
the transparent screen assembly configured to, in response to receiving the polarized light with the first output polarization on the first surface, (i) backscatter the polarized light with the first output polarization from the first surface, and (ii) block the polarized light with the first output polarization from the second surface.
